(19) United States
(12) Patent Application Publication
(10) Pub. No.: US 2022/0373314 A1
(43) Pub. Date: Nov. 24, 2022

(54) MEASURING DEVICE FOR MEASURING A DIAMETER OF A ROPE-SHAPED MATERIAL TO BE MEASURED

(71) Applicant: TEUFELBERGER FIBER ROPE GMBH, Wels (AT)

(72) Inventors: Robert TRAXL, Ebensee (AT); Gunter KAISER, Thalheim/Wels (AT); Erich RÜHRNÖSSL, Haid (AT); Björn ERNST, Gmunden (AT)

(21) Appl. No.: 17/754,095

(22) PCT Filed: Sep. 10, 2020
(86) PCT No.: PCT/EP2020/075368

§ 371 Date: Mar. 23, 2022

(30) Foreign Application Priority Data
Sep. 23, 2019 (EP) 19199032.4

(51) Int. Cl. G01B 3/20; G01B 5/08

(52) U.S. Cl. CPC G01B 3/20; G01B 5/08

(57) ABSTRACT

The invention relates to a measuring device for measuring a diameter of a rope-shaped material to be measured, with the material to be measured being a fibre rope, the measuring device comprising two measuring surfaces parallel to one another, a pressing means configured for pressing the measuring surfaces onto the material to be measured located between the measuring surfaces with a predetermined measuring force during a measuring process, and a measuring unit configured for measuring a distance between the measuring surfaces, with the measuring device being configured as a portable handheld device, the measuring device comprising a guiding device which can be placed onto the material to be measured for the measuring process, with the guiding device being arranged in relation to the measuring surfaces in such a way that the material to be measured assumes a predefined position relative to the measuring surfaces during the measuring process, and with the guiding device being configured in such a way that the material to be measured can be placed onto the guiding device on both sides of the measuring surfaces.

The invention relates to a measuring device for measuring a diameter of a rope-shaped material to be measured, with the material to be measured being a fibre rope, the measuring device comprising two measuring surfaces parallel to one another, a pressing means configured for pressing the measuring surfaces onto the material to be measured located between the measuring surfaces with a predetermined measuring force during a measuring process, and a measuring unit configured for measuring the distance between the measuring surfaces. In further aspects, the invention relates to a use of the above-mentioned measuring device and a method of measuring a diameter of a rope-shaped material to be measured by means of said measuring device.

Fibre ropes are increasingly used in applications that were previously reserved for steel ropes. This is due to the ever progressing development of the structure of fibre ropes and, respectively, the properties of the materials on which they are based, which give the fibre ropes favourable properties that come close to those of steel ropes or even surpass them. The use in crane systems is, for example, a particularly relevant area of application for fibre ropes, with the fibre rope being used as a load-bearing rope.

If fibre ropes with multilayer windings are used, the rope diameter, in particular, is crucial for a well-arranged winding pattern and hence minimal wear, for example, in the ascent areas from one winding layer to the next-higher winding layer. However, the diameter measurement of fibre ropes is much less accurate than that of steel ropes, which causes problems when one wishes to use a fibre rope instead of a steel rope.

Therefore, there is a need for measuring devices and measuring methods by means of which the diameter of fibre ropes can be determined particularly accurately and reliably. For example, a thickness gauge with two measuring surfaces is known from the prior art, wherein one of the measuring surfaces is spring-loaded relative to the other one in order to measure the thickness of a rope between the measuring surfaces. This thickness gauge can be used, for example, in a measuring method according to EN892:2016 for dynamic mountaineering ropes.

The above-mentioned thickness gauge has the drawback that jamming of the testing equipment happens frequently, as a result of which the diameter that is determined is too large. It is not possible to detect this error immediately during a single measurement so that measuring processes often have to be repeated in order to obtain more accurate measuring results.

Another method of measuring the diameter of fibre ropes is the so-called circumference measurement, a variant of which is specified in FDIS2307:2019, Chapter 9.4. In this method, a measuring tape is placed around the rope and the measuring result is subsequently divided by π in order to determine the diameter. However, this measuring method produces a major inaccuracy when calculating the diameter, since it assumes a circular cross-section and fails to take into account the ovality that is common in fibre ropes.

Another method of determining the diameter of a fibre rope is known from JP 2017/122612 A. Therein, an optical measuring method is proposed which, however, requires a constant power supply and is complex to implement. Measuring devices used in this method are expensive and cumbersome to use, rendering them impractical.

In case of steel ropes, the diameters are often measured with manually operated calipers. However, this procedure is unsuitable for fibre ropes, since the manual force of the tester influences the measuring result and jamming of the measuring device—similar as with the above-mentioned thickness gauge for fibre ropes—happens frequently. In addition, steel ropes usually do not have a circular cross-section due to their structure, but they form a polygon with a clear geometry. Therefore, measuring methods for steel ropes are not directly applicable to fibre ropes.

The same problem arises with the measuring device for elevator cables described in the document JP H05 30708 U. The measuring device comprises an extensive base plate on which two measuring equipments and two clamps are provided, each of which are movable with complex mechanisms. Before the diameter of the elevator cable is measured, it is clamped by two clamps to the left and right of the measuring equipments and the cumbersome measuring device is positioned on the elevator cable. However, this positioning mechanism using clamps is unsuitable for measuring fibre ropes, since the force applied by the clamps would alter the diameter of the fibre rope.

Furthermore, it is known from EP 1 855 079 A2 to install a measuring device itself in a holding device in order to specify its position in space. In this way, a clear reference can be created for follow-up measurements. However, this measuring device is unsuitable for being used for measuring the diameter of fibre ropes, since the measuring device cannot be applied directly to the freely positioned fibre rope.

Other static measuring devices for measuring sizes of batteries and, respectively, cylindrical bodies are known from the documents KR 2015 0036925 A and JP 560111101 A. CN 208 091 349 U additionally discloses a static measuring device for cables, which comprises a separate conveying device for supplying the material to be measured.

A measuring device configured as a comparator is known from US 2001/052191 A1, which, however, is not configured for the direct measurement of a diameter. Two measuring surfaces are used in this measuring device, with one of the measuring surfaces being spring-loaded. This comparator is used for a comparative measurement of soft workpieces such as those made of resin, for example, and provides a support for the workpiece, the support being arranged between the measuring surfaces. However, since this support holds the workpiece only at certain points, it is not suitable for preventing a rope from jamming during the measurement.

It is therefore an object of the invention to provide a measuring device and a measuring method for measuring a diameter of a rope-shaped material to be measured, which overcome the disadvantages of the prior art. In particular, the measuring device and the measuring method should allow a measurement that is particularly precise and not prone to errors.

This object is achieved in a first aspect of the invention by a measuring device for measuring a diameter of a rope-shaped material to be measured, with the material to be measured being a fibre rope, the measuring device comprising two measuring surfaces parallel to one another, a pressing means configured for pressing the measuring surfaces onto the material to be measured located between the measuring surfaces with a predetermined measuring force during a measuring process, and a measuring unit configured for measuring the distance between the measuring surfaces, with the measuring device being configured as a portable handheld device, the measuring device comprising a guiding device which can be placed onto the material to be measured for the measuring process, and with the guiding device being arranged in relation to the measuring surfaces in such a way that the material to be measured assumes a predefined position relative to the measuring surfaces during the measuring process, and with the guiding device being configured in such a way that the material to be measured can be placed on the guiding device on both sides of the measuring surfaces.

Usually, the material to be measured is pretensioned during a measuring process, i.e., the material to be measured is tensioned by means of a tensioning device, e.g., a testing machine, so that the material to be measured is available for the measuring process while being stationary. For the measuring process, the guiding device is placed onto the pretensioned rope before the measuring surfaces are pressed on, after which the measuring surfaces press against the material to be measured. Using the guiding device, the measuring device according to the invention allows to ensure a predefined position of the measuring surfaces relative to the material to be measured. In this way, the rope is effectively prevented from jamming or swerving against the measuring surfaces, respectively.

So far, it has been possible to prevent the measuring surfaces from jamming only if the tester was particularly attentive during the measuring process or, respectively, by taking several measurements at the same measuring position on the material to be measured. With the solution according to the invention, the measuring surfaces are brought into a predefined position relative to the material to be measured already before the measuring surfaces are applied—and not only during the application process performed by the tester—so that the measuring surfaces are prevented from jamming on the material to be measured and measuring errors associated therewith are reduced.

In contrast to solutions involving clamps, the guiding surfaces allow the material to be measured to be positioned in relation to the measuring surfaces without the application of force. As a result, the measuring device according to the invention can be used for measuring the diameter of fibre ropes without changing the diameter of the material to be measured. In addition, the measuring device can be moved quickly around or on the material to be measured in order to determine the diameter of the material to be measured at other points. As a result, it is also possible to use only one pair of measuring surfaces to quickly determine several measured values.

The guiding device preferably comprises two essentially planar guiding surfaces, which particularly preferably are arranged in such a way that the measuring surfaces press against the material to be measured in an area located between the guiding surfaces, whereby the measuring surfaces can be prevented from jamming on the material to be measured to an even greater extent. The two guiding surfaces allow the material to be measured to rest on the guiding surfaces to the left and right of the measuring surfaces. In this case, the two guiding surfaces can be formed on separate components or on a single component which, optionally, is interrupted. Particularly preferably, the guiding surfaces lie within a common plane.

In the above-mentioned embodiment, the guiding surfaces are advantageously arranged essentially perpendicular to the measuring surfaces. This measure also enables that the measuring surfaces on the material to be measured are even less prone to jamming.

To be particularly suitable for use with fibre ropes for crane systems, the measuring surfaces are preferably essentially circular and have a diameter of 20 to 150 mm. As a result, the measuring surfaces of the measuring device have a size that essentially corresponds at least to the rope diameter of fibre ropes used in crane systems.

Particularly preferably, the measuring surfaces have a modularly exchangeable design so that the size of the measuring surfaces is adjustable to the material to be measured. This is particularly advantageous if ropes with different rope diameters are to be measured. By replacing the measuring surfaces, it can be provided that a different measuring device with measuring surfaces of different sizes does not have to be used for each material to be measured.

The pressing means is preferably configured for pressing the measuring surfaces against the material to be measured with a maximum measuring force of 50 N. This pressure can be chosen as a function of the rope diameter and, on the one hand, is low enough to prevent the material to be measured from being deformed and, on the other hand, this pressure is high enough, however, so that the required accuracy of the measuring device can be ensured.

Furthermore, it is advantageous if the roughness of the measuring surfaces is Ra≤0.8. In principle, the lower the roughness value Ra, the more accurate is the measurement allowed by the measuring surfaces. Sufficient accuracy is already achieved with the preferred value of Ra≤0.8.

The resolution of the measuring unit is preferably at least 0.01 mm, particularly preferably essentially 0.001 mm. This has turned out to be particularly favourable for applications of diameter measurement in fibre ropes.

The measuring device is preferably configured with at least one handle. The handle enables easier handling of the measuring device so that the guiding surfaces of the measuring device can be placed on the material to be measured with greater ease.

In a particularly preferred embodiment, the measuring device comprises a holding device which is placeable on the material to be measured essentially opposite to the guiding device and which is configured for resting on the material to be measured with such a low force that the measuring device continues to be rotatable around the material to be measured when the holding device is placed on the material to be measured. Practical tests have shown that the determined measured values are even more accurate as a result of this measure, since the holding device also prevents the material to be measured from escaping or, respectively, jamming in a direction away from the guiding device. However, it should be noted that the holding device should not be placed on the material to be measured with a force so large that it would crush the fibre rope, thus influencing the measuring result. At the same time, the force applied by the holding device should be large enough so that, for example, a manual trembling of the hand of the user of the measuring device will not affect the measuring result. Accordingly, the holding device is placed only loosely on the material to be measured, i.e., in such a way that the measuring device continues to be rotatable preferably manually around the material to be measured when the holding device is placed on the material to be measured. In other words, the guiding device continues to act as a bearing surface rather than as part of a clamp. The holding device can be articulated to the measuring device in such a way that the holding device is pressed manually onto the material to be measured without any further application of force and is held relative to the guiding device with a pawl, for example. In another embodiment, a spring could prestress the holding device relative to the guiding surface so that the material to be measured is held between the guiding device and the holding device with a predetermined force. However, when dimensioning the spring, it needs to be made sure that the maximum spring force is only so high that the diameter of the fibre rope is not altered. To facilitate the rotation of the measuring device around the material to be measured, the holding device can comprise one or several rollers which reduce the frictional resistance during rotation.

In an alternative embodiment, no holding device located opposite to the guiding device is provided, i.e., the measuring device is configured such that the material to be measured can be positioned on the guiding device without any counterforce. In this way, it is achieved that the diameter of the fibre rope cannot be influenced at all or, respectively, cannot be influenced inadvertently. In addition, the measuring device can be rotated even faster around the material to be measured in order to determine several measured diameter values about the circumference of the rope.

In an advantageous embodiment, the measuring device is part of a measuring system which furthermore comprises a tensioning device configured for pretensioning the material to be measured with a predetermined longitudinal tensile force. The purpose of tensioning is that the material to be measured is subjected to a uniform tension during the measurement so that comparable measuring results are provided. In addition, the guiding device of the measuring device can be placed more easily onto the rope that has been pretensioned by the tensioning device.

The tensioning device is preferably configured for pretensioning the material to be measured with a longitudinal tensile force that is greater than 0.5% of the minimum breaking force of the material to be measured and preferably essentially corresponds to 0.75% of the minimum breaking force of the material to be measured. Said 0.75% of the minimum breaking force essentially correspond to a load on a fibre rope for crane systems as a result of an empty hook of a crane. The tensioning device can therefore be implemented not only by a dedicated testing machine, but also by a crane which tensions the fibre rope by loading it with the empty hook.

In a second aspect, the invention relates to the use of said measuring device for measuring the diameter of a rope, preferably a fibre rope, or a cable, which furthermore is preferably pretensioned with a predetermined longitudinal tensile force.

In this case, it is preferred if a measuring device is used the measuring surfaces of which are essentially circular and have a diameter which corresponds to at least 1 times the diameter or 1.5 times the diameter of the rope to be measured. In doing so, either a measuring device with corresponding measuring surfaces can be selected from a plurality of measuring devices with measuring surfaces of different sizes or—if the measuring device has modularly exchangeable measuring surfaces—the measuring surfaces themselves can be selected independently of the rest of the measuring device.

In a third aspect, the invention relates to a method of measuring a diameter of a rope-shaped material to be measured by means of the above-mentioned measuring device, comprising—
pretensioning the material to be measured with a predetermined longitudinal tensile force;
placing the guiding device onto the material to be measured;
pressing the two measuring surfaces onto the material to be measured located between the measuring surfaces with the predetermined measuring force;
measuring and outputting the diameter of the material to be measured by measuring the distance between the measuring surfaces.

Said measuring method is characterized by a particularly high measuring accuracy, since jamming of the measuring surfaces on the material to be measured can be prevented effectively by placing the guiding device onto the material to be measured.

With the measuring device according to the invention, it makes sense in particular to perform the steps of placing, pressing and measuring at a measuring position, with the measuring device being rotated at least once around the material to be measured in the circumferential direction of the material to be measured after measuring has occurred at the same measuring position and the measuring step being repeated at least once in order to measure at least two diameters of the material to be measured at the same measuring position at different positions on the circumference so that preferably the minimum and the maximum diameters can be determined at the measuring position. If the measuring device is rotated around the material to be measured in the circumferential direction of the material to be measured, the rotation can occur through a predetermined angle, e.g., through 22.5°, 45°, 90°, 180°, 360° or 720°. The measuring and recording of the measured values, i.e., diameters, can be done continuously during the rotation, or only at the start point and the end point of the rotation, so that discrete measured values rather than continuous measured values are obtained. In particular, if discrete measured values are to be determined, the measurement of the diameter can be carried out at more than two positions on the circumference of the same measuring position. Even if the diameter is determined continuously during the rotation, it may be envisaged that the rotation takes place more than once, for example, if the measuring device is rotated twice around the entire circumference of the material to be measured. In case of a continuous measurement, it could be envisaged in another variant that the measuring device is rotated only by half or by another fraction of the circumference. The rotation of the measuring device around the material to be measured can take place even if the guiding device abuts the material to be measured and the measuring surfaces are pressed against the material to be measured. Alternatively, the guiding device and/or the measuring surfaces can also be moved away from the material to be measured prior to the rotation, which, however, is reasonable only when discrete diameters are being determined.

In the method according to the invention, it is preferred if the steps of placing, pressing and measuring are performed at least at three different measuring positions, which preferably each are spaced apart by 0.5 m and preferably are spaced from a rope end or a clamping point by at least 2 m. A measuring result can thereby be obtained which is more representative of the entire material to be measured than a measuring result at a single measuring position.

Furthermore, it is preferred if the measuring device is rotated continuously, for example very slowly and carefully, around the circumference of the rope at each of the measuring positions in order to determine a minimum diameter and a maximum diameter of the material to be measured at the respective measuring position.

With the measuring device according to the invention, particularly accurate and representative measuring results can be achieved if the two last-mentioned embodiment variants of the method are combined. For this purpose, the measuring method comprises the step of calculating an arithmetic mean from measured minimum and maximum values of the diameter of the material to be measured at least at three different measuring positions. This arithmetic mean can subsequently be used as the measured diameter of the material to be measured.

Advantageous and non-limiting embodiments of the invention are explained in further detail below with reference to the drawings.

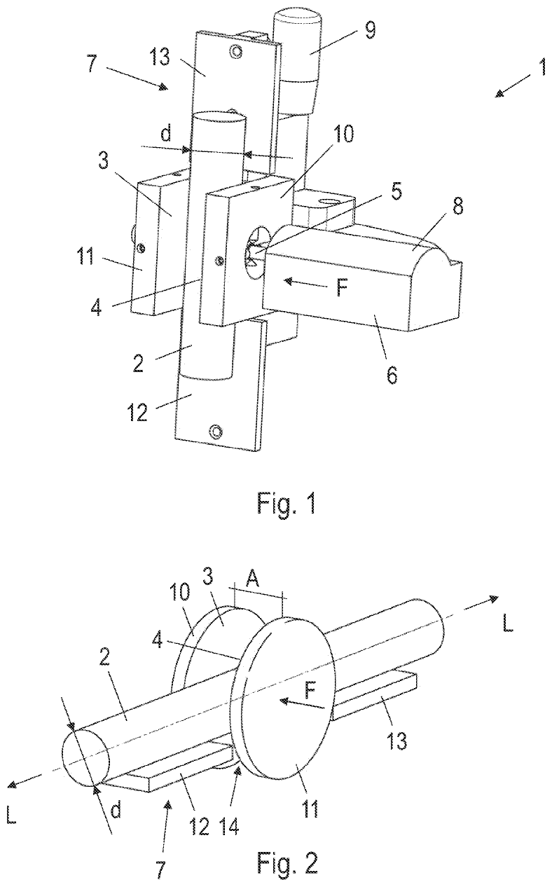

FIG. 1 shows the measuring device according to the invention in a perspective view.

FIG. 2 shows in detail the measuring surfaces and guiding surfaces of an exemplary embodiment of the measuring device according to the invention.

FIG. 1 shows a measuring device 1 for measuring a diameter d of a rope-shaped material to be measured 2. The material to be measured 2 can generally be a rope, e.g., a fibre rope or a steel rope, or a cable.

In particular, the measuring device 1 is supposed to be used for measuring the diameter d of a high-strength fibre hoist rope for cranes. Fibre ropes or, respectively, fibre hoist ropes generally have, for example, a rope core comprising high-strength synthetic fibres or strands, and a textile sheath. High-strength fibre ropes or, respectively, fibre hoist ropes are manufactured from high-strength manmade fibres, as is commonly known to a person skilled in the art. “High-strength” is herein understood to denote fibres with a tensile strength of at least 14 cN/dtex, preferably a tensile strength greater than 24 cN/dtex, particularly preferably greater than 30 cN/dtex. UHMWPE fibres (e.g., Dyneema®), aramid fibres, LCP fibres and PBO fibres are known as high-strength fibre types with appropriate tensile strengths.

The measuring methods currently available are not sufficiently accurate for fibre ropes. The measuring device 1 illustrated herein should therefore be configured in particular for determining the diameter of fibre ropes or, respectively, fibre hoist ropes.

In order to fulfil this purpose, the measuring device 1 comprises two measuring surfaces 3, 4 parallel to one another, a pressing means 5 and a measuring unit 6. According to the invention, the measuring device furthermore comprises a guiding device 7, which is described in further detail below. If the measuring device 1 is configured as a portable handheld device, it may furthermore comprise at least one handle or, as in the embodiment shown, two handles 8, 9. A portable handheld device is herein understood to be a measuring device 1 weighing, for example, up to 0.2 kg, up to 0.5 kg, up to 1 kg, up to 2 kg or up to 5 kg.

The measuring surfaces 3, 4 can be formed on measuring disks 10, 11, for example. As shown in FIG. 1, the measuring surfaces 3, 4 can have a rectangular base surface. FIG. 2 shows an alternative embodiment with measuring surfaces 3, 4 which are essentially circular. Other configurations of the measuring surfaces 3, 4 are also possible.

In the embodiments of FIGS. 1 and 2, the measuring surfaces 3, 4 are planar. Alternatively, the measuring surfaces 3, 4 could also be bent, for example, if measuring cylinders are used instead of the measuring disks 10, 11, with the cylinder axes of the measuring cylinders being arranged in parallel to a longitudinal direction of the material to be measured 2.

The circular measuring surfaces 3, 4 of FIG. 2 have, for example, a diameter which corresponds at least to the diameter d of the material to be measured 2. For use in the measurement of diameters d of fibre ropes of crane systems, the measuring surfaces 3, 4 can therefore have a diameter of 20 to 150 mm, for example. In case of rectangular measuring surfaces 3, 4 as shown in FIG. 1, those can have a length and a width which correspond, for example, at least to the diameter d of the material to be measured so that the measuring surfaces 3, 4 have a respective length and width of, for example, 20 to 150 mm.

It is therefore evident that the sizes of the measuring surfaces 3, 4 should each be adjusted to the material to be measured 2. On the one hand, it is possible for this purpose that several measuring devices 1 are provided, each having measuring surfaces 3, 4 with different diameters. Alternatively, the measuring surfaces 3, 4 can have a modularly exchangeable design, for example, as a result of the modularly exchangeable design of the measuring disks 10, 11, so that the size of the measuring surfaces 3, 4 can be adjusted to the material to be measured 2 independently of the rest of the measuring device 1. For example, the measuring device 1 can be provided or, respectively, sold as a set with at least two pairs of measuring surfaces 3, 4 or, respectively, pairs of measuring discs 10, 11 of different sizes. The choice of the most suitable measuring surfaces 3, 4 does not have to be determined by a previous measurement, but can be determined by eye.

The measuring surfaces 3, 4 have, for example, a roughness Ra, with Ra amounting to ≤0.8. The roughness Ra is defined in ÖNORM EN ISO 4287:2012. The lower the roughness Ra of the measuring surfaces 3, 4, the more precisely can the measuring device 1 determine the diameter d of the material to be measured 2.

The pressing means 5 is configured for pressing the measuring surfaces 3, 4 against the material to be measured 2 located between the measuring surfaces 3, 4 with a predetermined measuring force F during a measuring process. In the illustrated embodiments, it is provided that one of the measuring surfaces 3 is fixedly formed on the measuring device 1 and the other measuring surface 4 is displaceable so that the pressing means 5 acts only on the displaceable measuring surface 4, pushing it in the direction of the rigid measuring surface 3. Alternatively, both measuring surfaces 3, 4 could be movable and could each act on the material to be measured 2 with a predetermined proportion of the measuring force F.

The pressing means 5 can, for example, have a spring for applying the measuring force F. As an alternative to the spring, the measuring device 1 could also comprise pneumatic means or other means as the pressing means 5, which are configured for exerting a constant measuring force onto the material to be measured. The pressing means 5 is usually configured for limiting the measuring force F on the material to be measured 2 so that a maximum of 50 N will act on the material to be measured 2, for example. As a result, the radial deformation of the material to be measured 2 can be limited. For example, with a measuring length of 100 mm, a length-related contact pressure of 0.5 N/mm is created, for example, which is low enough so that the material to be measured 2 will not be deformed.

For determining the diameter d of the material to be measured 2, the two measuring surfaces 3, 4 are placed against the measuring force F (which can be suspended for this purpose) at a distance that is greater than the diameter d of the material to be measured 2 in order to position the material to be measured 2 between the measuring surfaces 3, 4. Thereupon, the pressing means 5 presses the measuring surfaces 3, 4 onto the material to be measured 2 with the measuring force F in order to determine the diameter d thereof.

In order to avoid jamming of the measuring surfaces 3, 4 on the test material 2 during said process, the measuring device 1 comprises the above-mentioned guiding device 7. The guiding device 7 is arranged in relation to the measuring surfaces 3, 4 in such a way that the material to be measured 2 assumes a predefined position relative to the measuring surfaces 3, 4 during the measuring process. For example, the guiding device 7 provides at least one support for this purpose, which is arranged immovably relative to at least one of the measuring surfaces 3, 4 or relative to a central plane or, respectively, a zero plane of two measuring surfaces 3, 4 that are movable relative to one another.

In the exemplary embodiment of FIG. 1, the guiding device 7 comprises two essentially planar guiding surfaces 12, 13 which are arranged in such a way that the measuring surfaces 3, 4 press onto the material to be measured 2 abutting the guiding surfaces 12, 13. The guiding surfaces 12, 13 lie in a common plane and enable the material to be measured 2 to rest on both sides of the measuring surfaces 3, 4, depending on the position of the measuring device 1 relative to the material to be measured 2, e.g., to the left and right of or, respectively, above and below the measuring surfaces 3, 4. The guiding surfaces 12, 13 each have a length of, for example, 25 mm.

FIG. 2 shows in detail that, in this embodiment, an area 14 is provided between the guiding surfaces 12, 13 in which the measuring surfaces 3, 4 press onto the material to be measured 2 with the measuring force F. In other embodiments, it is also possible that only one of the lateral guiding surfaces 12, 13 is provided. Also, no area 14 could be left between the guiding surfaces 12, 13 so that the guiding device 7 has a continuous design. This might be provided, for example, if the guiding device 7 is narrower than the material to be measured 2 or if the guiding device 7 is spaced from the measuring surfaces 3, 4 in such a way that the measuring surfaces 3, 4 press onto the material to be measured 2 next to the guiding device 7.

The guiding surfaces 12, 13 are essentially planar and are arranged in a plane perpendicular to the measuring surfaces 3, 4. Alternatively, the guiding surfaces 12, 13 could also be arranged obliquely to the measuring surfaces, or the guiding surfaces 12, 13 might not be planar, but curved or angled, in order to be adjusted to the shape of the material to be measured 2.

After the guiding device 7 has been placed with the guiding surfaces 12, 13 onto the pretensioned material to be measured 2, the measuring surfaces 3, 4 are pressed onto the material to be measured 2 with the measuring force F, whereby the risk of jamming of the measuring surfaces 3, 4 on the material to be measured 2 is reduced by the guiding device 7.

As soon as the measuring surfaces 3, 4 press onto the material to be measured 2 with the measuring force F and assume a constant distance A from one another, the diameter d of the material to be measured 2 can be determined from the distance A between the measuring surfaces 3, 4. For this purpose, the measuring device 1 comprises the measuring unit 6 which is configured for measuring the distance A between the measuring surfaces 3, 4 and for determining the diameter d of the material to be measured 2 therefrom. The measuring unit 6 can, for example, have an analog or digital design and be integrated into the pressing means 5 or configured as a separate unit. Subsequently, the measuring unit 6 can indicate the measured or determined value, for example, via an optical display, can output it via an interface or can deposit it in a memory.

In particular, the roughness Ra of the measuring surfaces 3, 4 and the resolution of the measuring unit 6 determine the achievable measuring accuracy of the measuring device 1. In total, the measuring device 1 has, for example, a measuring accuracy of at least 0.1 mm, preferably of essentially 0.01 mm. However, it is possible to deviate therefrom, depending on the area of application.

The material to be measured 2 is preferably pretensioned during a measuring process so that it is tight during the measurement. For this purpose, a tensioning device (not shown) can be used by means of which the material to be measured 2 can be pretensioned with a predetermined longitudinal tensile force L. For example, the tensioning device can pretension the material to be measured 2 with a longitudinal tensile force L that is greater than 0.5% of the minimum breaking force (MBK) of the material to be measured 2 and preferably essentially corresponds to 0.75% of the minimum breaking force of the material to be measured 2.

For example, a dedicated testing equipment in a laboratory or in a workshop is suitable as a tensioning device, wherein the material to be measured 2 can be loaded with a predetermined longitudinal tensile force L by means of the testing equipment.

In order to determine the diameter d of the material to be measured 2 in use, it may also be envisaged that the material to be measured 2 is held in a raised position at one end (or generally at one point) and is loaded with a mass at another end (or generally at another point) so that the longitudinal tensile force L is achieved by the mass under gravity.

Particularly preferably, the diameter d of a fibre hoist rope can thereby be measured when it is suspended from a crane and is loaded with an empty hook as a mass. It has been shown that, in cranes, the dead weight of the empty hook essentially exerts a longitudinal force of 0.75% of the minimum breaking force of the material to be measured 2 onto the material to be measured 2.

The method described below is particularly suitable as a method of measuring a diameter d of the r rope-shaped material to be measured 2 with the above-mentioned measuring device 1. Initially, the material to be measured 2 is pretensioned with the predetermined longitudinal tensile force L by means of the tensioning device. Thereupon, a tester takes the measuring device 1, optionally selects the measuring surfaces 3, 4 in doing so, depending on the material to be measured 2, and applies the guiding device 7 to the material to be measured 2, with the measuring surfaces 3, 4 being spaced apart from one another in such a way that the material to be measured 2 is located between them and the measuring surfaces 3, 4 still do not touch the material to be measured 2. For this purpose, the measuring surfaces 3, 4 can beforehand be placed at a distance from one another that is greater than the diameter d of the material to be measured 2.

Subsequently, the two measuring surfaces 3, 4 are pressed by the pressing means 5 onto the material to be measured 2 located between the measuring surfaces 3, 4 with the predetermined measuring force F. The measuring unit 6 then measures the distance A between the measuring surfaces 3, 4 and determines the diameter d of the material to be measured 2 therefrom and outputs it as explained above.

The diameter d of the material to be measured 2 can be determined at a measuring position with this measuring method. However, particularly preferably, the diameter d of the material to be measured 2 is measured for a measuring position by continuously rotating the measuring device 1 around the circumference of the rope in order to determine a minimum diameter and a maximum diameter at a measuring position, for example. For this purpose, the measuring device can, for example, be rotated very slowly and carefully around the circumference of the rope in order to determine a minimum diameter and a maximum diameter of the material to be measured at the respective measuring position.

In addition, the measuring process is preferably carried out for more than one measuring position, i.e., the steps of placing, pressing and measuring are performed at least at three different measuring positions. For example, the measuring positions are each spaced apart by 0.5 m and preferably are spaced from a rope end or a clamping point by at least 2 m.

If the diameter d of the material to be measured 2 is determined at more than one measuring position and a minimum diameter and a maximum diameter of the material to be measured are measured at the respective measuring position, the method may preferably comprise the step of calculating an arithmetic mean from measured minimum and maximum values of the diameter of the material to be measured at least at three different measuring positions. This provides a particularly precise and representative diameter d of the material to be measured 2.

1.-19. (canceled)

20. A measuring device for measuring a diameter of a rope-shaped material to be measured, with the material to be measured being a fibre rope, the measuring device comprising two measuring surfaces parallel to one another, a pressing means configured for pressing the measuring surfaces with a predetermined measuring force during a measuring process onto the material to be measured, which is located between the measuring surfaces, and a measuring unit configured for measuring the distance between the measuring surfaces,
with the measuring device being configured as a portable handheld device,
wherein the measuring device comprises a guiding device which can be placed onto the material to be measured for the measuring process, with the guiding device being arranged in relation to the measuring surfaces in such a way that the material to be measured assumes a predefined position relative to the measuring surfaces during the measuring process,
with the guiding device being configured in such a way that the material to be measured can be placed onto the guiding device on both sides of the measuring surfaces.

21. A measuring device according to claim 20, wherein the guiding device comprises two essentially planar guiding surfaces.

22. A measuring device according to claim 20, wherein the guiding device comprises an essentially planar guiding surface which is arranged in such a way that the measuring surfaces press onto the material to be measured abutting the guiding surface.

23. A measuring device according to claim 21, wherein the guiding surfaces or, respectively, the guiding surface are/is arranged essentially perpendicular to the measuring surfaces.

24. A measuring device according to claim 20, wherein the measuring surfaces are essentially circular and have a diameter of 20 to 150 mm.

25. A measuring device according to claim 20, wherein the measuring surfaces are constructed to be modularly exchangeable so that the size of the measuring surfaces is adjustable to the material to be measured.

26. A measuring device according to claim 20, wherein the pressing means is configured for pressing the measuring surfaces against one another with a maximum measuring force of 50 N.

27. A measuring device according to claim 20, wherein the roughness of the measuring surfaces is Ra≤0.8.

28. A measuring device according to claim 20, wherein the measuring accuracy of the measuring device is at least 0.1 mm.

29. A measuring device according to claim 20, wherein the measuring device has at least one handle.

30. A measuring device according to claim 20, wherein the measuring device comprises a holding device which is placeable on the material to be measured essentially opposite to the guiding device and which is configured for resting on the material to be measured with such a low force that the measuring device continues to be rotatable around the material to be measured when the holding device is placed on the material to be measured.

31. A measuring system comprising the measuring device according to claim 20 and a tensioning device configured for pretensioning the material to be measured with a predetermined longitudinal tensile force.

32. A use of the measuring device according to claim 20 for measuring the diameter of a fibre rope.

33. A use according to claim 32, wherein the measuring surfaces are essentially circular and have a diameter which corresponds at least to the diameter of the rope to be measured.

34. A use according to claim 32, wherein the tensioning device pretensions the material to be measured with a longitudinal tensile force that is greater than 0.5% of the minimum breaking force of the material to be measured.

35. A method of measuring a diameter of a rope-shaped material to be measured by means of a measuring device according to claim 20, the material to be measured being a fibre rope, comprising
pretensioning the material to be measured with a predetermined longitudinal tensile force;
placing the guiding device to the material to be measured;
pressing the two measuring surfaces onto the material to be measured located between the measuring surfaces with the predetermined measuring force;
measuring and outputting the diameter of the material to be measured by measuring the distance between the measuring surfaces.

36. A method according to claim 35, wherein the steps of placing, pressing and measuring are performed at a measuring position and wherein the measuring device is rotated at least once around the material to be measured in the circumferential direction of the material to be measured after measuring has occurred at the same measuring position and the measuring step is repeated at least once in order to measure at least two diameters of the material to be measured at the same measuring position at different positions on the circumference.

37. A method according to claim 35, wherein the steps of placing, pressing and measuring are performed at least at three different measuring positions, wherein the measuring device is rotated continuously around the circumference of the material to be measured at each of the different measuring positions in order to determine a minimum diameter and a maximum diameter of the material to be measured at the respective measuring position, and wherein the method furthermore comprises the step of calculating an arithmetic mean from measured diameters of the material to be measured at least at three measuring positions.

38. A method according to any of claim 35, wherein a tensioning device pretensions the material to be measured with a longitudinal tensile force that is greater than 0.5% of the minimum breaking force of the material to be measured.

39. A measuring device according to claim 21, wherein the two essentially planar guiding surfaces are arranged in such a way that the measuring surfaces press against the material to be measured in an area located between the guiding surfaces.
